(19) United States
(12) Patent Application Publication
(10) Pub. No.: US 2008/0075164 A1
(43) Pub. Date: Mar. 27, 2008

(54) MOTION PICTURE ENCODING APPARATUS AND METHOD

(75) Inventor: Atsushi Matsumura, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/832,396

(22) Filed: Aug. 1, 2007

(30) Foreign Application Priority Data
Sep. 27, 2006 (JP) 2006-263493

(51) Int. Cl. H04B 1/66

(52) U.S. Cl. 375/240.12

(57) ABSTRACT

A bits assignment unit assigns target bits to pictures of an input image by analyzing the input image. A prediction unit predicts a buffer occupancy of a hypothetical decoder buffer based on the target bits. A segmentation unit generates segments by temporarily dividing the input image. Each segment has a plurality of pictures. An initial delay calculation unit calculates an initial delay of each segment based on the buffer occupancy. The initial delay is a difference between a decode start time of a first picture of each segment and a transfer completion time of a last picture of a previous segment to the decoder buffer. An encoder generates segmented bit streams by encoding each segment based on the target bits and the initial delay. A connection unit generates one bit stream by connecting the segmented bit streams.

### CROSS-REFERENCE TO RELATED APPLICATIONS

This application is based upon and claims the benefit of priority from prior Japanese Patent Application No.2006-263493, filed on Sep. 27, 2006; the entire contents of which are incorporated herein by reference.

### FIELD OF THE INVENTION

The present invention relates to a motion picture encoding apparatus and a method for encoding a motion picture in parallel by temporal segmentation.

### BACKGROUND OF THE INVENTION

In order to improve encoding speed of a motion picture, encoding processing of the motion picture can be executed in parallel by using a plurality of CPU or hardware. For example, a method for dividing (segmenting) one picture (one frame) into regions and encoding each region in parallel is disclosed in JP-A No.2005-136633 (Kokai). In this method, communication between parallel encoding of some regions occurs many times per one picture.

On the other hand, a method for temporally dividing an input image (a series of pictures) into each segment (a plurality of pictures) and encoding each segment in parallel is taken into consideration. In this method, communication between parallel encoding of some segments occurs several times per each segment. As a result, communication overhead is low and encoding speed is high.

As to temporal-segmentation encoding, encoded bit-stream of each segment must be connected to generate one bit stream. In this case, continuity of encoded bits (occupancy in a decoder buffer) between two bit streams to be connected must be guaranteed. Briefly, encoded bits (occupancy in the decoder buffer) at the end of present segment must be above encoded bits (occupancy in the decoder buffer) at the start of next segment. For example, a method for guaranteeing continuity of buffer-occupancy to connect a plurality of bitstreams is disclosed in JP-A No.2004-297829 (Kokai) and JP-A No.2003-111024 (Kokai).

In the above method, a latter part of previous bit stream (encoded bits of previous segment) at a segmentation point is re-encoded in order to connect two bit streams at the segmentation point. In this case, by controlling re-encoded bits below original encoded bits of the latter part, buffer-occupancy (occupancy in the decoder buffer) is adjusted. Accordingly, picture quality often falls at the segmentation point.

On the other hand, in case of encoding at the segmentation point, even if buffer-occupancy is adjusted, correct buffer-occupancy at the start of the next segment is not determined until encoding of the previous segment is completed.

FIG. 5 shows transition of buffer-occupancy in case of encoding without segmentation, i.e., time-variation of encoded bits. FIG. 6 shows transition of ideal initial buffer-occupancy at each segmentation point in case of encoding with segmentation. Actually, correct initial buffer-occupancy cannot be determined without actual encoding. Accordingly, in case of encoding with temporal segmentation, initial buffer-occupancy at each segmentation point must be determined.

As a simple method to solve above problem, as shown in FIG. 7, a predetermined value is assigned to initial occupancy (or initial delay) at each segmentation point. In order to guarantee continuity of occupancy at each segmentation point, bit rate is controlled so that actual occupancy of the end of the present segment is above initial occupancy (predetermined) of the start of the next segment. In this case, as shown in FIG. 8, a difference between actual encoded bits (dotted line) and ideal encoded bits (solid line) of each picture appears. Briefly, actual encoded bits of each picture decreases in comparison with ideal encoded bits. As a result, high-quality encoding is difficult in comparison with encoding without temporal segmentation.

### SUMMARY OF THE INVENTION

The present invention is directed to a motion picture encoding apparatus and a method for effectively controlling bit rate of a motion picture in case of encoding with temporal segmentation.

According to an aspect of the present invention, there is provided an apparatus for encoding a motion picture, comprising: a bits assignment unit configured to assign target bits to pictures of an input image by analyzing the input image: a prediction unit configured to predict a buffer occupancy of a hypothetical decoder buffer based on the target bits; a segmentation unit configured to generate segments by temporarily dividing the input image, each segment having a plurality of pictures; an initial delay calculation unit configured to calculate an initial delay of each segment based on the buffer occupancy, the initial delay being a difference between a decode start time of a first picture of each segment and a transfer completion time of a last picture of a previous segment to the decoder buffer; an encoder configured to generate segmented bit streams by encoding each segment based on the target bits and the initial delay; and a connection unit configured to generate one bit stream by connecting the segmented bit streams.

According to another aspect of the present invention, there is also provided a method for encoding a motion picture, comprising: assigning target bits to pictures of an input image by analyzing the input image: predicting a buffer occupancy of a hypothetical decoder buffer based on the target bits; generating segments by temporarily dividing the input image, each segment having a plurality of pictures; calculating an initial delay of each segment based on the buffer occupancy, the initial delay being a difference between a decode start time of a first picture of each segment and a transfer completion time of a last picture of a previous segment to the decoder buffer; generating segmented bit streams by encoding each segment based on the target bits and the initial delay; and generating one bit stream by connecting the segmented bit streams.

According to still another aspect of the present invention, there is also provided a computer readable medium storing program codes for causing a computer to encode a motion picture, the program codes comprising: a first program code to assign target bits to pictures of an input image by analyzing the input image: a second program code to predict a buffer occupancy of a hypothetical decoder buffer based on the target bits; a third program code to generate segments by temporarily dividing the input image, each segment having a plurality of pictures; a fourth program code to calculate an initial delay of each segment based on the buffer occupancy, the initial delay being a difference between a decode start time of a first picture of each segment and a transfer completion time of a last picture of a previous segment to the decoder buffer; a fifth program code to generate segmented bit streams by encoding each segment based on the target bits and the initial delay; and a sixth program code to generate one bit stream by connecting the segmented bit streams.

### BRIEF DESCRIPTION OF THE DRAWINGS

FIG. 1 is a block diagram of a motion picture encoding apparatus according to embodiments of the present invention.

FIG. 2 is a flow chart of a motion picture encoding method according to a first embodiment.

FIG. 3 is a flow chart of a motion picture encoding method according to a second embodiment.

FIG. 4 is a flow chart of a motion picture encoding method according to a third embodiment.

FIG. 5 is a transition chart of buffer-occupancy without temporal segmentation.

FIG. 6 is a transition chart of buffer-occupancy without temporal segmentation in case of ideal.

FIG. 7 is a transition chart of buffer-occupancy without temporal segmentation in case that initial occupancy is equal.

FIG. 8 is a transition chart of buffer-occupancy without temporal segmentation in case of rate-controlling.

FIG. 9 is a transition chart of buffer-occupancy without temporal segmentation in case of two-paths controlling.

FIG. 10 is a transition chart of buffer-occupancy without temporal segmentation in case of two-paths controlling and initial occupancy controlling.

FIG. 11 is a transition chart of buffer-occupancy without temporal segmentation in case that initial occupancy is estimated low.

### DETAILED DESCRIPTION OF THE EMBODIMENTS

Hereinafter, various embodiments of the present invention will be explained by referring to the drawings. The present invention is not limited to the following embodiments.

### FIRST EMBODIMENT

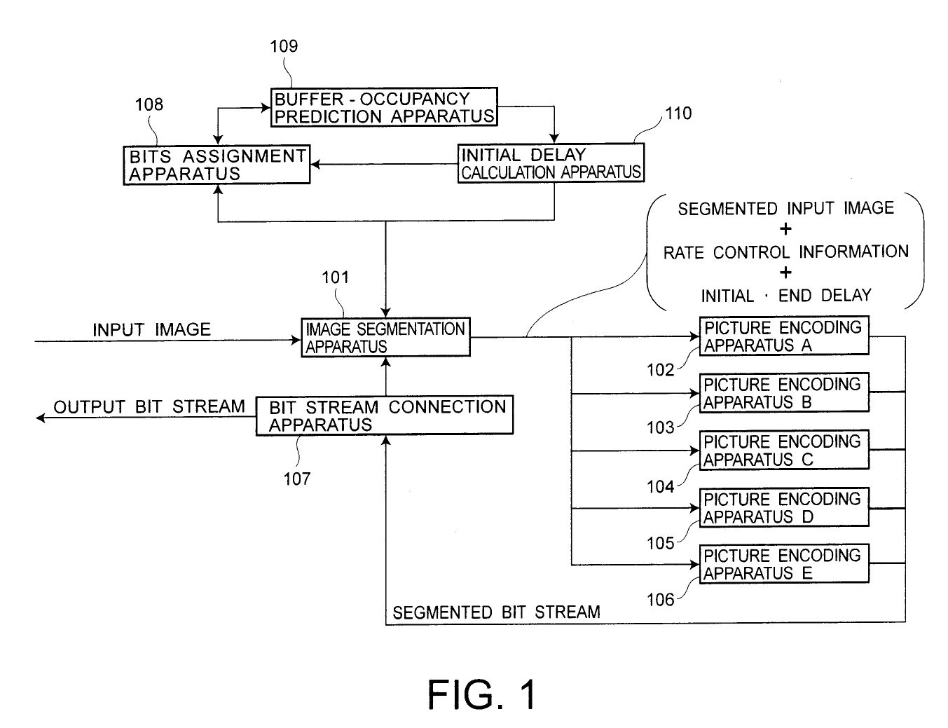

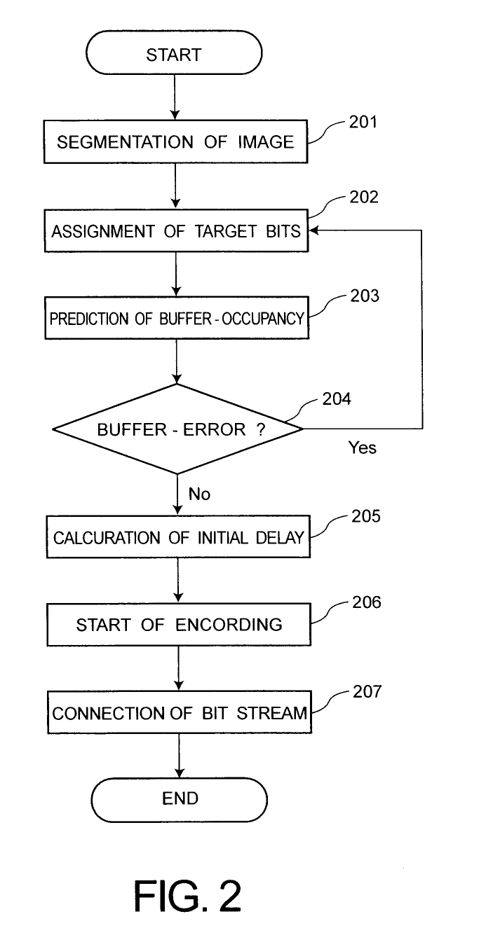

Hereinafter, a motion picture encoding apparatus of the first embodiment is explained by referring to FIGS. 1 and 2.

(1) Component of the Motion Picture Encoding Apparatus:

FIG. 1 is a block diagram of the motion picture encoding apparatus using temporal segmentation according to the first embodiment. In FIG. 1, an image segmentation apparatus 101 receives an input image having a large number of pictures (motion picture), and temporally divides (segments) the input image into a plurality of segments. Each segment comprises a plurality of pictures (frames or fields). Furthermore, the image segmentation apparatus 101 outputs various encoding parameter of each segment.

Picture encoding apparatus 102˜106 receives each segment (a plurality of pictures) with the encoding parameter, and outputs a bit stream (encoded data) by compressing each segment. Actually, the picture encoding apparatus 102˜106 compresses each segment using H.264/MPEG-4 AVC.

A bit stream connection unit 107 receives bit stream of each segment (encoded data with temporal segmentation), and connects each bit stream to be temporarily reproducible in right order. As a result, one bit stream of the motion picture is output.

A bits assignment apparatus 108 analyzes the input image, and estimates target bits (estimated bits) to be assigned to each picture of the input image. A buffer-occupancy prediction apparatus 109 simulates time-variation of buffer-occupancy (transition of occupancy in a hypothetical decoder buffer) based on the target bits calculated. An initial delay calculation apparatus 110 calculates an initial delay (delay time of initial decoding) at each segmentation point of the input image based on the time-variation of buffer-occupancy.

(2) Operation of Motion Picture Encoding Apparatus:

Next, operation of the motion picture encoding apparatus is explained by referring to FIG. 2. FIG. 2 is a flow chart of processing of the motion picture encoding apparatus according to the first embodiment.

(2-1) Temporal Segmentation of Picture:

First, the image segmentation apparatus 101 receives an input image (a series of pictures), and divides (segments) the input image into segments (a plurality of pictures) along time axis direction (S201). A method for setting a segmentation point is explained.

As a first method, a segmentation point is set to a scene change part. For example, inter-picture correlation, i.e., a scene change part, is set as a segmentation point. In case of encoding after segmentation, a first picture in each segment is encoded as IDR picture (I picture except for H.264). Encoding as I picture is more effective because inter-picture correlation is low at a scene change part. Accordingly, encoding efficiency becomes high by setting a segmentation point to the scene change part. Furthermore, a chapter indicated by a user and a position used for random-access is often set as a scene change part.

As a second method, the input image is segmented by a predetermined number of frames (pictures). If a segmentation point is set to a scene change part, a length of each segment (a number of frames divided) is unequal. As a result, encoding time of each segment is unequal, and suitable parallel-encoding of each segment cannot be executed.

For example, in the first embodiment, five units of picture encoding apparatuses which encodes each segment exist. In case of a total number of an input image is 10000 frames, when the input image is divided into 2000 (=10000/5) frames, load of each picture encoding apparatus is equalized, and effective parallel-encoding is possible. Furthermore, if the input image is divided by smaller unit, i.e., “10000/(5×α)” frames, difference of processing time (caused by encoding difficulty) between adjacent two segments is distributed.

As a third method, the input image is divided by a multiple of GOP (Group Of Pictures). This set method is based on control of inter-frame prediction structure and encoding efficiency.

As a fourth method, by combining the first method with the second method, after the input image is divided by each scene change point, for example, if a number of frames in the segment is above 150, the segment is further divided by 150 frames.

(2-2) Analysis of Input Image:

The bits assignment apparatus 108 receives an input image, and assigns target bits by analyzing characteristic of the input image. A method for assigning target bits by analyzing picture characteristic is as follows.

An input image is encoded by a predetermined quantization step (temporary encoding), encoding complexity is obtained from the encoding result, and target bits are assigned to each picture of the input image. This method is called “two-paths bit rate control”.

In this method, temporary encoding is executed once. Accordingly, GOP structure of the input image is determined using segmentation information, and accuracy of encoding raises using GOP structure. The segmentation information is obtained from the image segmentation apparatus 101. In case of temporary encoding, parallel-encoding can be executed by the picture encoding apparatuses 102˜105, and encoding time can be reduced.

In the above explanation, the target bits assignment apparatus 108 operates using two paths bit rate control. However, the first embodiment is not limited to this target bits assignment method. For example, as a simple analysis method, encoding complexity may be calculated using difference between adjacent two pictures, inter-picture activity, or square sum of residual signal after motion compensation.

As a unit of target bits assignment, any of GOP, a picture, a slice, and a macro block (MB) may be used. In the first embodiment, picture is used as the unit.

(2-3) Simulation of Buffer-Occupancy:

The buffer-occupancy prediction apparatus 109 simulates occupancy of a hypothetical (virtual) decoder buffer based on target bits assigned to each picture. As the hypothetical decoder buffer, for example, VBV (Video Buffer Verify) is used for MPEG-2 and MPEG-4. CPB (Coding Picture buffer) is used for H.264.

In case of target bits assignment by unit of slice or MB, target bits of slice or MB is accumulatively converted to target bits of picture, and the same simulation is executed.

In case of target bits assignment by unit of GOP, buffer-simulation is executed by unit of GOP. In this case, buffer-error may occur in GOP because status of the decoder buffer is not unknown in GOP. Accordingly, this is not the best method.

However, in the first embodiment, even if target bits are assigned to GOP, parallel-encoding processing can be realized. This operation is explained afterwards.

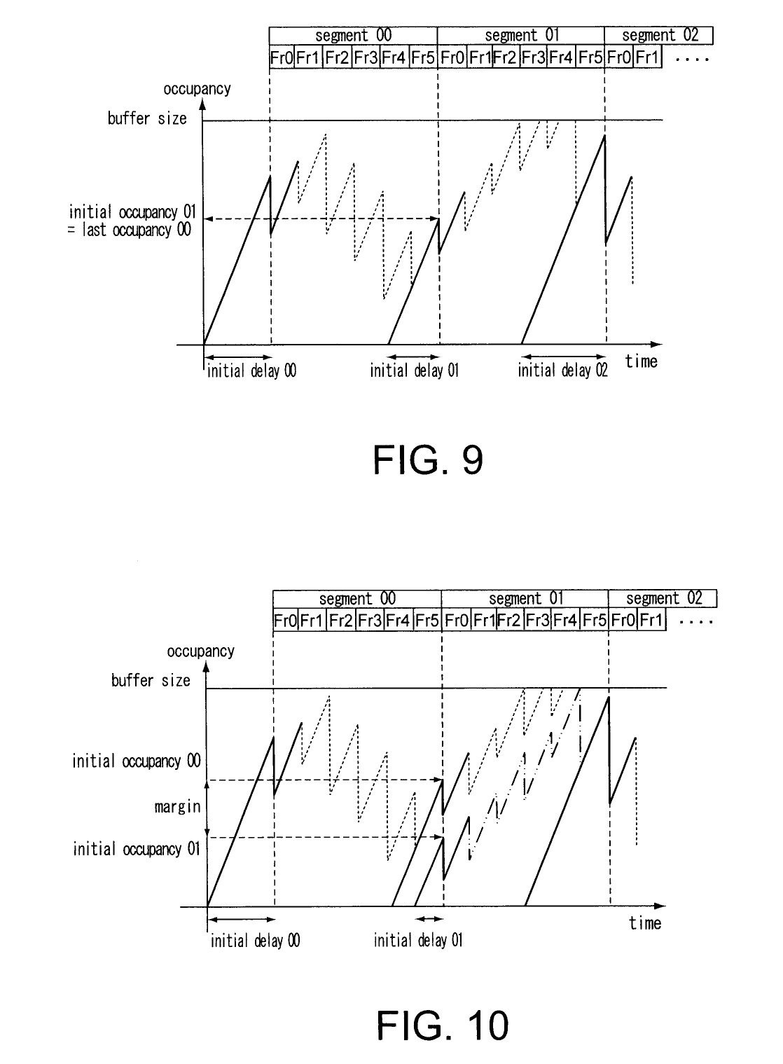

As the hypothetical decoder buffer, VBV model and CPB model are selectively applied. In case of CBR (Constant Bit Rate), “VBV=CPB”. In case of VBR (Variable Bit Rate), delay of VBV is larger than (or equal to) delay of CPB when transfer of encoded bits to the decoder buffer stops. H.264 is originally CPB model. However, in the first embodiment, buffer-occupancy is simulated using VBV model. FIG. 9 shows simulation result of buffer-occupancy based on target bits assignment.

(2-4) Detection of Buffer-Error:

As a result of simulation, for example, in case of detecting buffer-underflow or buffer-overflow (CBR), this information is informed to the bits assignment apparatus 108 (S204). Based on this information, the bits assignment apparatus 108 assigns target bits to each picture again. In case of not detecting buffer-error, next processing is executed.

(2-5) Calculation of Initial Delay:

The initial delay calculation apparatus 110 calculates initial delay based on the buffer-occupancy simulated (S205). An equation to calculate initial delay is as follows.

initial_delay=buffer_occupancy/transfer_bitrate

In the above equation, “initial_delay” represents delay time (second) of a first picture in a segment. In case of H.264, initial delay is 90000 units (90 kHz). Accordingly, the first picture is encoded with 90000 multiple of initial delay. In above equation, “buffer_occupancy” represents occupancy (bits) of the hypothetical decoder buffer, and “transfer_bitrate” represents speed (bit/second) of encoded bit to transfer to the hypothetical decoder buffer.

In other words, initial delay is the transfer completion time of the last picture of the previous segment to the hypothetical decoder buffer subtracted from the extraction time of first picture of present segment from the hypothetical decoder buffer. The extraction time of the first picture from the hypothetical decoder buffer is an estimated time (value along a horizontal axis in FIG. 9) based on occupancy of the hypothetical decoder buffer. In this case, the extraction time is equal to decode start time of the first picture. Accordingly, the initial delay is the transfer completion time of the last picture of the previous segment to the hypothetical decoder buffer subtracted from the decode start time of the first picture of the present segment.

In case of encoding each segment, initial delay of the first picture of each segment is necessary as initial parameter, and the initial delay is calculated by the initial delay calculation apparatus 110. As mentioned-above, even if target bits are assigned to GOP, by simulating occupancy of the hypothetical decoder buffer based on target bits assigned to GOP, the initial delay can be calculated. In case of CBR, based on buffer-occupancy simulated, the initial delay is calculated by the above equation. In case of VBR, by devising calculation method, bit rate for temporal segmentation-encoding is stably controlled.

In order to guarantee continuity of occupancy of the hypothetical decoder buffer at segmentation point, in case of VBR, “occupancy of last picture of segment>=occupancy of first picture of next segment” is necessary. Errors between assigned bits and actual encoded bits may occur. Accordingly, the picture encoding apparatuses 102˜106 encode with error-feedback by controlling bit rate. For example, when encoded bits continually generate more than assigned bit at the first half of a segment, suppress of target bits is feedback at the second half of the segment, and picture quality may fall at the second half of segment. In this case, if “initial delay of first picture of next segment” is estimated low, margin to guarantee continuity of occupancy of the hypothetical decoder buffer at segmentation point occurs, and suppress of target bit need not be feedback at the second half of the segment. As a result, picture quality is more stable. As a method to estimate low “initial delay of first picture of next segment”, as shown in FIG. 10, occupancy of the hypothetical decoder buffer is simulated using CPB model.

In the buffer-occupancy prediction apparatus 109, buffer-occupancy is simulated by VBV model. In this case, in the initial delay calculation apparatus 110, simulation of buffer-occupancy is corrected by CPB model, and the initial delay is calculated as a low value. As a result, target bits assigned to each picture are not affected, and picture quality is stably maintained.

(2-6) Encoding:

The picture encoding apparatuses 102˜106 receive the initial delay, bits assignment information, another encoding parameter and each segment (a plurality of pictures) , and encode each segment based on received information (S206).

Usually, an error between assigned bits and actual encoded bits occurs. Accordingly, bit rate control is necessary. Especially, in case that the hypothetical decoder buffer is situated based on CBR, “occupancy of last picture of segment=occupancy of first picture of next segment” is indispensable condition, and bit rate control is important.

In case of encoding the segment, by receiving the initial delay of first picture of next segment as initial parameter, “occupancy of last picture of the segment” is determined as a target. Accordingly, when encoding of the segment is completed, if “actual occupancy of last picture of the segment” is above the target, filler data (or stuffing data) is output so that “actual occupancy of last picture of the segment=the target (occupancy of first picture of next segment)”.

Furthermore, in case that the initial delay is calculated based on VBR, in the same way as the above operation, filler data is output at the last picture of the segment. In this case, bit rate is controlled so that “actual occupancy of last picture of the segment=the target (occupancy of first picture of next segment)”.

In order to raise convergence of bit rate of last picture in segment, if bit rate control is strongly feedback to the last picture, image quality of the last picture in the segment often falls and subjective image quality is poor. Rather than strong feedback at the last picture, target bits of margin for the last picture are controlled from all pictures. If target bits of the margin remain at the last picture, filler data (or stuffing data) to correct target bits of the last picture are output. In this case, image quality is stable over all pictures. After completing encoding of the segment, bit stream of the segment is output.

(2-7) Connection:

The bit stream connection apparatus 107 receives a bit stream of each segment (segmented bit stream) from each picture encoding apparatus 102˜106, and connects the segmented bit streams to reproduce in right order (S207). After storing all segmented (encoded) bit streams, all segmented bit streams may be connected. Alternatively, a plurality of segmented bit streams temporarily connectable may be arbitrarily connected.

The bit stream connection apparatus 107 receives each segmented bit stream from picture encoding apparatus 102˜106. Accordingly, the bit stream connection apparatus 107 can judge which picture encoding apparatus completes encoding. By sending this information to the image segmentation apparatus 101, the image segmentation apparatus 101 sends picture data of next segment to the picture encoding apparatus which completed encoding. In this case, encode processing can be continually executed. In order to request picture data of next segment, the picture encoding apparatus 102˜106 may inform completion of encoding to the image segmentation apparatus 101. After completing encoding of all segments, the bit stream connection apparatus 107 connects each segmented bit streams of all segments, and outputs one bit stream. In this way, encoding with temporal segmentation is completed.

### THE SECOND EMBODIMENT

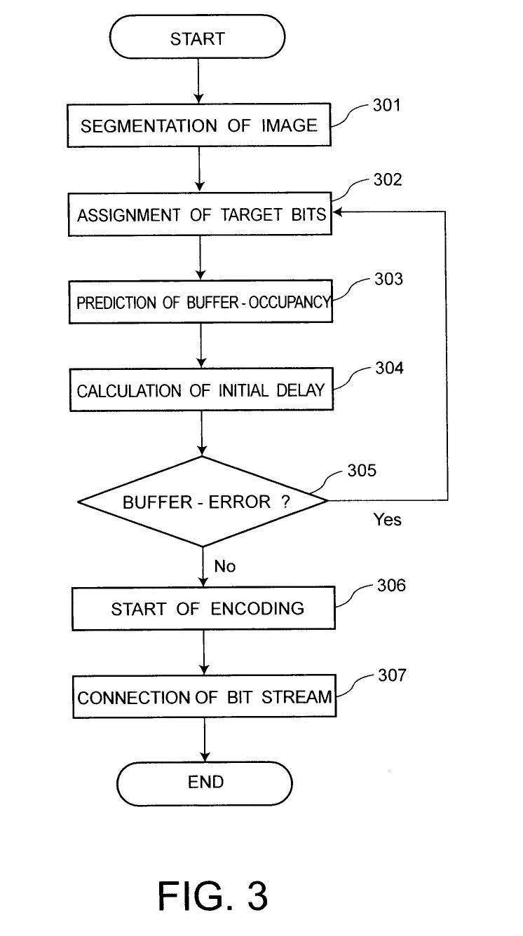

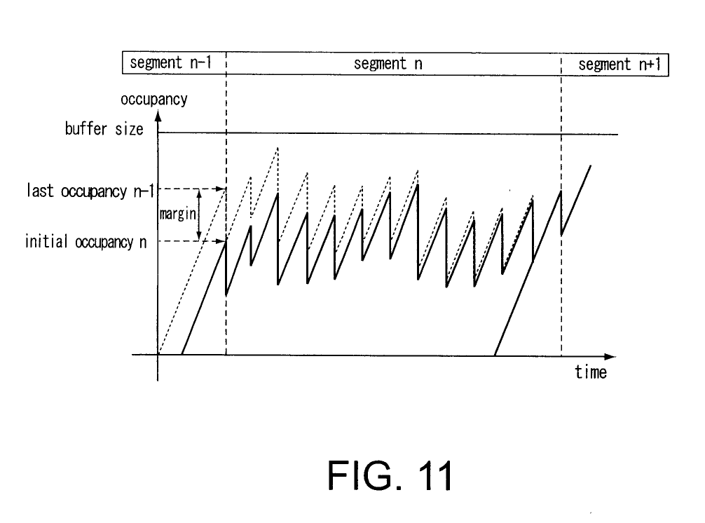

Hereinafter, the motion picture encoding apparatus of the second embodiment is explained by referring to FIGS. 3 and 11. Component of the motion picture encoding apparatus is the same as the first embodiment in FIG. l. FIG. 3 is a flow chart of processing of the motion picture encoding apparatus according to the second embodiment.

Processing from start to buffer-simulation (S301˜S303) by the buffer-occupancy prediction apparatus 109 (based on VBV model) is the same as the first embodiment. In the second embodiment, a method for calculating initial delay at each segmentation point is different from the first embodiment.

In case of VBR, a picture having scene hard to encode is often assigned bits equal to transfer encoded bits. In this case, in the first embodiment, initial buffer-occupancy cannot be estimated low because of “VBV=CPB”. Accordingly, in the second embodiment, by estimating low the initial buffer-occupancy at predetermined rate, the initial delay calculation apparatus 110 calculates initial delay (S304).

FIG. 11 shows transition of buffer-occupancy in case of lowly estimating buffer-occupancy. In FIG. 11, buffer-simulation of buffer-occupancy prediction apparatus 109 is represented by a dotted line. The initial delay calculation unit 110 estimates initial delay to be low (as margin), and adjusts buffer-simulation and bits assigned (represented by a solid line in FIG. 11). After adjusting the bits assigned, in order to adjust buffer-simulation, the buffer-occupancy prediction apparatus 109 may simulate buffer-occupancy based on the bits adjusted.

As a method for adjusting target bits (assigned) and buffer-simulation, for example, bits of the margin are equally subtracted from bits assigned to each picture of the segment. If bits assigned to each picture are different by encoding method of each picture (I picture, P picture, B picture), target bits of each picture may be decreased in proportion to ratio of the margin to total bits assigned to the segment.

As a result of adjusting bits (assigned) and buffer-simulation, it is confirmed whether buffer-error occurs (S305). In case of detecting buffer-error, this information is notified to the bits assignment apparatus 108. The bits assignment apparatus 108 assigns target bits to each picture based on the information again. In case of not detecting buffer-error, processing is forwarded to the next step. Following encoding processing (S306, S307) is the same as the first embodiment.

### THE THIRD EMBODIMENT

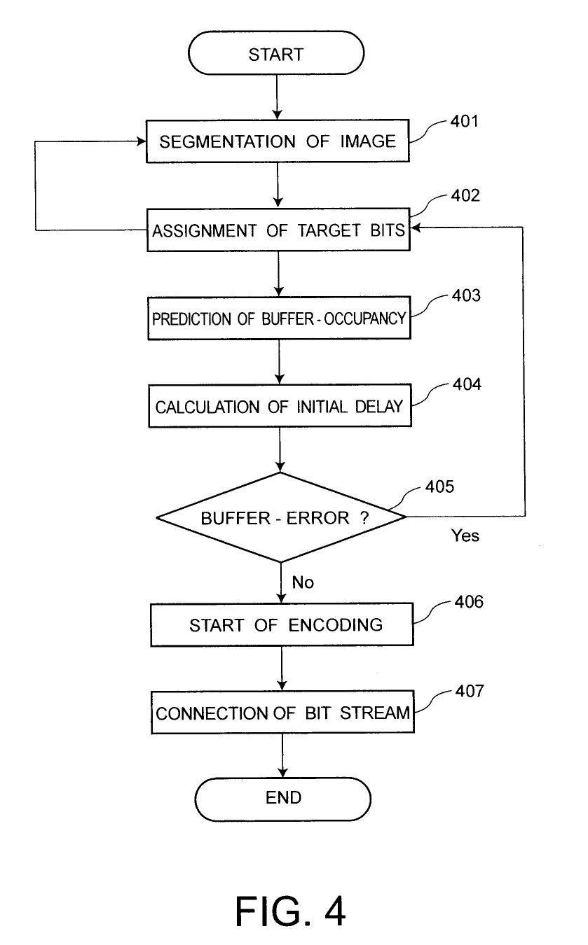

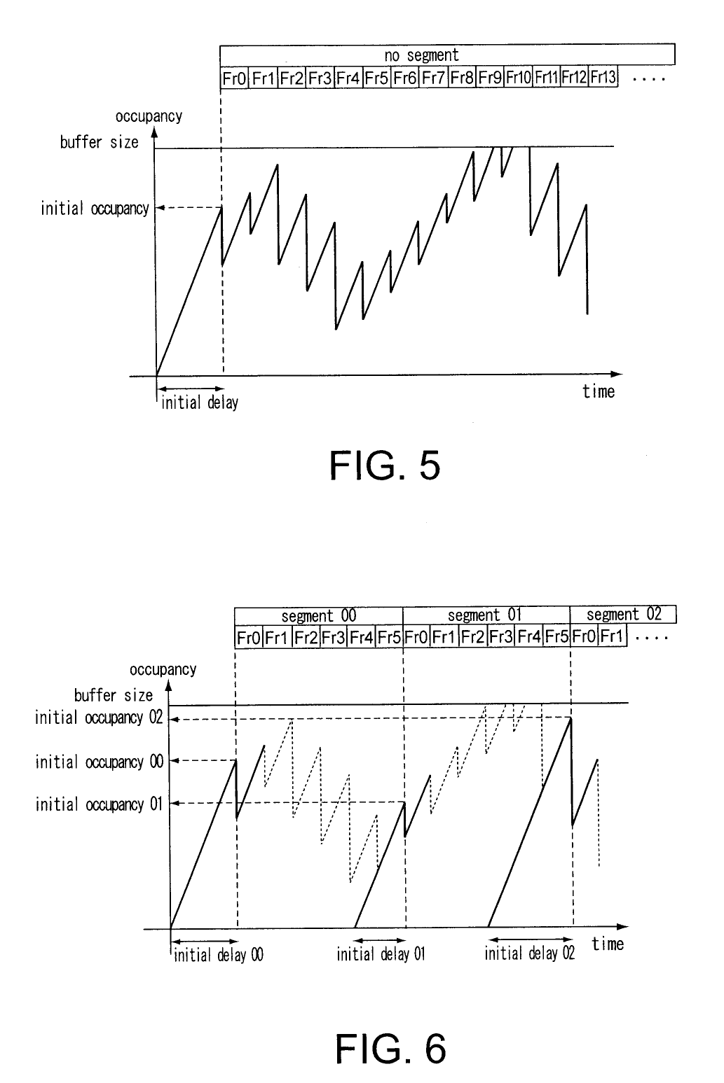

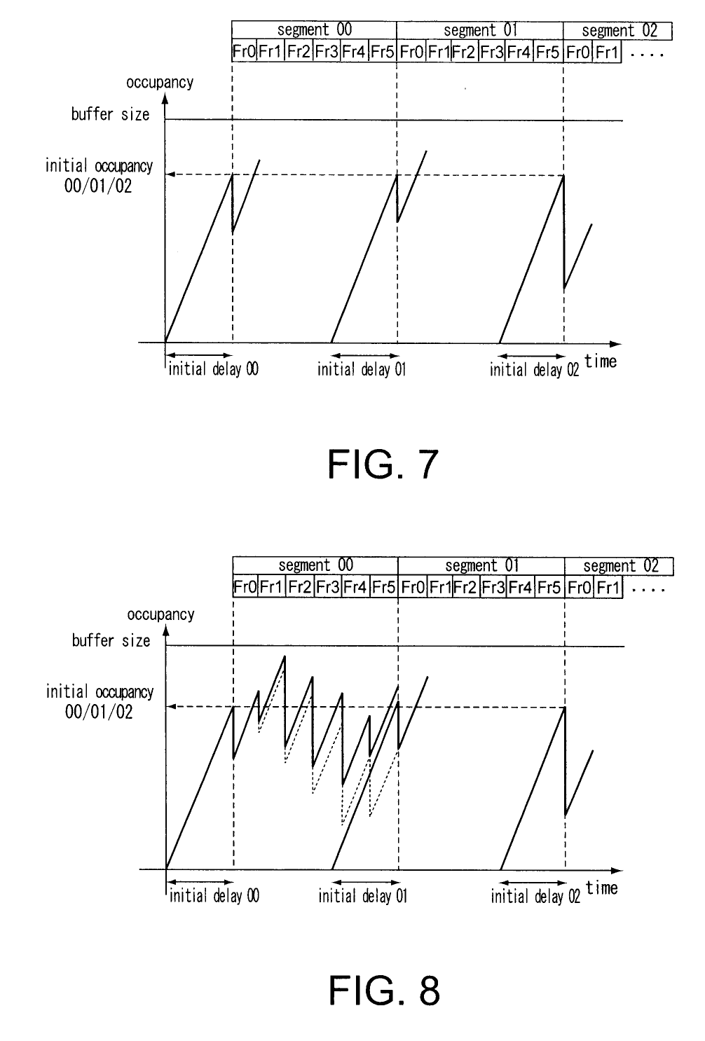

Hereinafter, the motion picture encoding apparatus of the third embodiment is explained by referring to FIG. 4. Component of the motion picture encoding apparatus is same as the first embodiment in FIG. 1. FIG. 4 is a flow chart of processing of the motion picture encoding apparatus according to the third embodiment.

Processing from start to buffer-simulation (S401˜S403) by the buffer-occupancy prediction apparatus 109 (based on VBV model) is the same as the first embodiment. In the third embodiment, processing after simulation of the buffer-occupancy prediction apparatus 109 is different from the first embodiment.

As mentioned in the first and second embodiments, margin is estimated at first picture of segment in order to guarantee continuity of the decoder buffer. In this case, if buffer-occupancy of the first picture is very low, margin cannot be sufficiently estimated for the last picture of previous segment. Accordingly, after buffer-simulation, in order not to set a segmentation point to a picture position having buffer-occupancy below a predetermined value (For example, 20% of size of the decoder buffer), the image segmentation apparatus 101 corrects the segmentation point of the input image.

As a method to correct the segmentation point, two adjacent pictures including the segmentation point are merged without the segmentation point. In this case, new segmentation point may be set to a picture point having buffer-occupancy above a predetermined value (For example, 70% of size of the decoder buffer).

The predetermined value may be calculated from speed to transfer encoded bits to the decoder buffer or an average of encoded bits of the input image. If size of the decoder buffer is very large and if encoded bits transferred (or average of encoded bits) are very low, for example, the predetermined value may be 5% of size of the decoder buffer.

As to the input image having segmentation point corrected, the bits assignment apparatus 108 assigns target bits to each segment again, and the buffer-occupancy prediction apparatus 109 simulates buffer-occupancy based on assignment result of target bits. If buffer-occupancy of the segmentation point is not below the predetermined value, next processing is executed. Following processing is same as the second embodiment.

In the flowchart of the third embodiment, processing from S404 to end is the same as the second embodiment. However, these steps may be replaced by the first embodiment. Briefly, processing of S404 is removed after S405. In case of buffer-error, processing is returned to S402. In case of not buffer-error, processing is removed to S404.

In above embodiments, the picture encoding apparatuses 102˜106 compress the image using H.264/MPEG-4 AVC. However, encoding method is not limited to H.264/MPEG-4 AVC. For example, MPEG-2 or MPEG-4 may be applied.

Furthermore, in above embodiments, the number of the picture encoding apparatuses 102˜106 is five. However, the number of the picture encoding apparatuses is not limited to five. The larger the number of the picture encoding apparatuses is, the quicker the encoding speed is with higher parallel degree.

In the disclosed embodiments, the processing can be accomplished by a computer-executable program, and this program can be realized in a computer-readable memory device.

In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and soon. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for encoding a motion picture, comprising:
a bits assignment unit configured to assign target bits to pictures of an input image by analyzing the input image:
a prediction unit configured to predict a buffer occupancy of a hypothetical decoder buffer based on the target bits;
a segmentation unit configured to generate segments by temporarily dividing the input image, each segment having a plurality of pictures;
an initial delay calculation unit configured to calculate an initial delay of each segment based on the buffer occupancy, the initial delay being a difference between a decode start time of a first picture of each segment and a transfer completion time of a last picture of a previous segment to the decoder buffer;
an encoder configured to generate segmented bit streams by encoding each segment based on the target bits and the initial delay; and
a connection unit configured to generate one bit stream by connecting the segmented bit streams.

2. The apparatus according to claim 1,
wherein the encoder comprises a plurality of units each generating one segmented bit stream.

3. The apparatus according to claim 1,
wherein the initial delay calculation unit sets the initial delay of each segment not above the difference.

4. The apparatus according to claim 1,
wherein the initial delay calculation unit minimizes the initial delay of the first picture of a segment based on the buffer occupancy.

5. The apparatus according to claim 1, wherein,
when an actual initial delay of a next segment estimated at the last picture of a segment is above the initial delay of the next segment calculated by the initial delay calculation unit,
the encoder outputs stuffing data or filler data at the last picture of the segment so that the actual initial delay is equal to the initial delay.

6. The apparatus according to claim 1,
wherein the initial delay calculation unit subtracts the transfer completion time of the last picture of the previous segment from the decode start time of the first picture of a segment, and sets a subtraction result to the initial delay time.

7. The apparatus according to claim 1,
wherein the prediction unit predicts the buffer occupancy based on VBV model.

8. The apparatus according to claim 1,
wherein the segmentation unit divides adjacent two pictures having low correlation in the input image.

9. The apparatus according to claim 1,
wherein the segmentation unit divides the input image by unit of a predetermined number of pictures.

10. The apparatus according to claim 9,
wherein the predetermined number is multiple of GOP length.

11. The apparatus according to claim 9,
wherein the predetermined number has an upper limit that a total number of pictures of the input image is divided by a number of units of the encoders.

12. The apparatus according to claim 9, wherein,
when a number of pictures in a segment is above the predetermined number,
the segmentation unit further divides the segment by the predetermined number of pictures.

13. The apparatus according to claim 1,
wherein the segmentation unit divides the input image by a picture position having the buffer occupancy above a predetermined occupancy.

14. The apparatus according to claim 3,
wherein the bits assignment unit decreases the target bits already assigned based on the initial delay.

15. A method for encoding a motion picture, comprising:
assigning target bits to pictures of an input image by analyzing the input image:
predicting a buffer occupancy of a hypothetical decoder buffer based on the target bits;
generating segments by temporarily dividing the input image, each segment having a plurality of pictures;
calculating an initial delay of each segment based on the buffer occupancy, the initial delay being a difference between a decode start time of a first picture of each segment and a transfer completion time of a last picture of a previous segment to the decoder buffer;
generating segmented bit streams by encoding each segment based on the target bits and the initial delay; and
generating one bit stream by connecting the segmented bit streams.

16. A computer readable medium storing program codes for causing a computer to encode a motion picture, the program codes comprising:
a first program code to assign target bits to pictures of an input image by analyzing the input image:
a second program code to predict a buffer occupancy of a hypothetical decoder buffer based on the target bits;
a third program code to generate segments by temporarily dividing the input image, each segment having a plurality of pictures;
a fourth program code to calculate an initial delay of each segment based on the buffer occupancy, the initial delay being a difference between a decode start time of a first picture of each segment and a transfer completion time of a last picture of a previous segment to the decoder buffer;
a fifth program code to generate segmented bit streams by encoding each segment based on the target bits and the initial delay; and
a sixth program code to generate one bit stream by connecting the segmented bit streams.
